(19) United States
(12) Patent Application Publication
(10) Pub. No.: US 2025/0016738 A1
(43) Pub. Date: Jan. 9, 2025

(54) ATTENTION COMMANDS FOR MULTI-SUBSCRIBER IDENTITY MODULE DEVICES

(71) Applicant: Apple Inc., Cupertino, CA (US)

(72) Inventors: Vivek G. GUPTA, San Jose, CA (US); Vijay VENKATARAMAN, San Jose, CA (US); Rohit R. MATOLIA, Surat, Gujarat (IN)

(21) Appl. No.: 18/705,297

(22) PCT Filed: Oct. 26, 2022
(86) PCT No.: PCT/US2022/047870

§ 371 Date: Apr. 26, 2024

(30) Foreign Application Priority Data
Oct. 29, 2021 (IN) 202111049667

(51) Int. Cl. H04W 68/02; H04W 76/30; H04W 88/06

(52) U.S. Cl. CPC H04W 68/02; H04W 76/30; H04W 88/06

(57) ABSTRACT

Techniques for multi-universal subscriber identity module (MUSIM) operation include generating, by a terminal equipment (TE) of a device, an attention (AT) command. The AT command indicates a value of a parameter related to MUSIM operation of the device, such as whether to release a Non-Access Stratum (NAS) connection associated with a particular USIM of the device, whether to reject or restrict paging associated with the particular USIM of the device, or a requested (or selected) IMSI offset associated with the particular USIM of the device. The AT command is communicated from the TE to a mobile terminal (MT) of the device through a terminal adapter (TA).

### PRIORITY CLAIM

This application claims priority to Indian patent application No. 202111049667, filed on Oct. 29, 2021.

### TECHNICAL FIELD

This disclosure relates generally to attention (AT) commands for wireless devices, such as multi-universal subscriber identity module (MUSIM) devices.

### BACKGROUND

In many wireless communication networks, such as cellular networks, a user subscribes to a service provider (sometimes referred to as a “carrier”), who in turn provides services to the user via the wireless communication network that they operate. In order to identify and authenticate subscribers, each subscriber can be assigned subscriber identity information, such as an international mobile subscriber identity (IMSI) number and its related key. This information can be securely stored as part of a subscriber identity module (SIM) or universal SIM (USIM) in the subscriber's wireless device, such as on a universal integrated circuit card (UICC) inserted into or embedded in the wireless device.

In some cases, a user may wish to have multiple subscriptions with one or more carriers on a single wireless device. For example, a user may wish to have separate personal and business subscriptions without having to carry multiple wireless devices. To support this feature, some wireless devices can include multiple USIMs on the same or different UICCs, thereby enabling a user to register with and communicate over the network associated with the each USIM on a single wireless device.

### SUMMARY

The technology described here facilitates MUSIM operation by enabling a MUSIM device to set and retrieve values of MUSIM-related parameters based on its capabilities. In particular, new AT commands are defined that allow a terminal equipment (TE) of a MUSIM device to control the function of a mobile termination (MT) of the device in order to set and/or retrieve parameter values for various MUSIM features, including Non-Access Stratum (NAS) Connection Release, Paging cause Indication for Voice, Rejection of Paging Request, Paging Restrictions, and Paging Timing Collision Control. By defining a standard means by which a MUSIM device can set and/or retrieve values of MUSIM-related parameters, the technology improves MUSIM operation by, for example, reducing collisions among communications associated with separate USIMs, preventing interruptions that disrupt the user experience, and enabling more efficient allocation of device and network resources.

In general, in a first aspect, a device includes processing circuitry including a TE, a MT and a TA, the processing circuitry to: generate, by the TE, an AT command that indicates a value of a parameter related to MUSIM operation of the device, and communicate the AT command from the TE to the MT through the TA; and memory to store data related to the value of the parameter related to MUSIM operation of the device.

In general, in a second aspect, a method includes generating, by a TE of a device, an AT command that indicates a value of a parameter related to MUSIM operation of the device, and communicating the AT command from the TE to a MT of the device through a TA.

In general, in a third aspect, at least one non-transitory computer-readable medium stores instructions executable by at least one processor to perform operations including generating, by a TE of a device, an AT command that indicates a value of a parameter related to MUSIM operation of the device, and communicating the AT command from the TE to a MT of the device through a TA.

In general, in a fourth aspect combinable with any of the first through third aspects, the parameter includes a NAS connection release parameter, and the value of the NAS connection release parameter indicates whether to release a NAS connection between the device and a network node.

In general, in a fifth aspect combinable with the fourth aspect, the MT indicates to the network node whether to release the NAS connection between the device and the network node based on the value of the NAS connection release parameter.

In general, in a sixth aspect combinable with any of the first through fifth aspects, the parameter includes a paging rejection parameter, and the value of the paging rejection parameter indicates whether to reject paging of the device by a network node.

In general, in a seventh aspect combinable with the sixth aspect, the MT indicates to the network node whether to the device has rejected paging based on the value of the paging rejection parameter.

In general, in an eighth aspect combinable with any of the first through seventh aspects, the parameter includes a paging restriction parameter, and the value of the paging restriction parameter indicates whether paging is not restricted, all paging is restricted, all paging is restricted except for voice service, all paging is restricted except for a specified public data network (PDN) connection or protocol data unit (PUD) session, or all paging is restricted except for voice services and the specified PDN connection or PDU session.

In general, in a ninth aspect combinable with the eighth aspect, a value of a one or more other paging restriction parameters indicate the specified PDN connection or PDU session.

In general, in a tenth aspect combinable with the eighth aspect, the MT indicates to a network node one or more paging restrictions based on the value of the paging restriction parameter.

In general, in an eleventh aspect combinable with any of the first through tenth aspects, the parameter includes a paging collision parameter, and the value of the paging collision parameter indicates whether to present an unsolicited return code in response to a change in an IMSI offset associated with the device.

In general, in a twelfth aspect combinable with any of the first through eleventh aspects, the parameter includes a paging collision parameter, and the value of the paging collision parameter indicates a requested IMSI offset for the device or a selected IMSI offset for the device.

In general, in a thirteenth aspect combinable with any of the first through twelfth aspects, the MT transmits, to a network node, a message based on the value of the parameter during an Evolved Packet System Mobility Management (EMM) Tracking Area Update or Service Request procedure, or during a 5G Mobility Management (5GMM) Registration Request or Service Request procedure.

In general, in a fourteenth aspect combinable with any of the first through thirteenth aspects, an AT command response is communicated from the MT to the TE through the TA in response to the AT command.

The details of one or more implementations are set forth in the accompanying drawings and the description below. Other features and advantages will be apparent from the description and drawings, and from the claims.

### BRIEF DESCRIPTION OF DRAWINGS

FIG. 1 illustrates an example of a wireless communication system.

FIG. 2 illustrates an example of infrastructure equipment.

FIG. 3 illustrates an example of a device.

FIG. 4 illustrates an example architecture of a device.

FIG. 5 illustrates an example process for setting and/or retrieving values of MUSIM-related parameters.

Like reference symbols in the various drawings indicate like elements.

### DETAILED DESCRIPTION

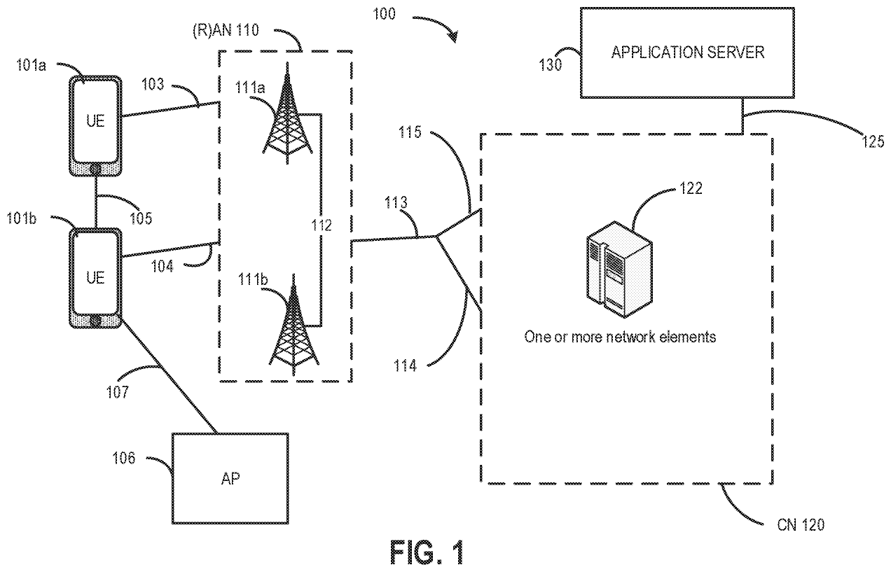

FIG. 1 illustrates an example of a wireless communication system 100. For purposes of convenience and without limitation, the example system 100 is described in the context of Long Term Evolution (LTE) and Fifth Generation (5G) New Radio (NR) communication standards as defined by the Third Generation Partnership Project (3GPP) technical specifications (TSs). More specifically, the wireless communication system 100 is described in the context of a Non-Standalone (NSA) networks that incorporate both LTE and NR, for example, E-UTRA (Evolved Universal Terrestrial Radio Access)-NR Dual Connectivity (EN-DC) networks, and NE-DC networks. However, the wireless communication system 100 may also be a Standalone (SA) network that incorporates only NR. Furthermore, other types of communication standards are possible, including future 3GPP systems (e.g., Sixth Generation (6G)) systems, IEEE 802.16 protocols (e.g., WMAN, WiMAX, etc.), or the like.

As shown by FIG. 1, the system 100 includes UE 101a and UE 101b (collectively referred to as “UEs 101” or “UE 101”). In this example, UEs 101 are illustrated as smartphones (e.g., handheld touchscreen mobile computing devices connectable to one or more cellular networks), but may also comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, MTC devices, M2M, IoT devices, and/or the like.

The UEs 101 may be configured to connect, for example, communicatively couple, with RAN 110 or multiple RANs 110 (such as where the UE 101 is a MUSIM UE). In some examples, the RAN 110 may be an NG RAN or a 5G RAN, an E-UTRAN, or a legacy RAN, such as a UTRAN or GERAN. As used herein, the term “NG RAN” or the like may refer to a RAN 110 that operates in an NR or 5G system 100, and the term “E-UTRAN” or the like may refer to a RAN 110 that operates in an LTE or 4G system 100. The UEs 101 utilize connections (or channels) 103 and 104, respectively, each of which comprises a physical communications interface or layer (discussed in further detail below).

In this example, the connections 103 and 104 are illustrated as an air interface to enable communicative coupling, and can be consistent with cellular communications protocols, such as a GSM protocol, a CDMA network protocol, a PTT protocol, a POC protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In some examples, the UEs 101 may directly exchange communication data via a ProSe interface 105. The ProSe interface 105 may alternatively be referred to as a SL interface 105 and may comprise one or more logical channels, including but not limited to a PSCCH, a PSSCH, a PSDCH, and a PSBCH.

The UE 101b is shown to be configured to access an AP 106 (also referred to as “WLAN node 106,” “WLAN 106,” “WLAN Termination 106,” “WT 106” or the like) via connection 107. The connection 107 can comprise a local wireless connection, such as a connection consistent with any IEEE 802.11 protocol, wherein the AP 106 would comprise a wireless fidelity (Wi-Fi®) router. In this example, the AP 106 is shown to be connected to the Internet without connecting to the core network of the wireless system (described in further detail below). In various examples, the UE 101b, RAN 110, and AP 106 may be configured to utilize LWA operation and/or LWIP operation. The LWA operation may involve the UE 101b in RRC CONNECTED being configured by a RAN node 111a-b to utilize radio resources of LTE and WLAN. LWIP operation may involve the UE 101b using WLAN radio resources (e.g., connection 107) via IPsec protocol tunneling to authenticate and encrypt packets (e.g., IP packets) sent over the connection 107. IPsec tunneling may include encapsulating the entirety of original IP packets and adding a new packet header, thereby protecting the original header of the IP packets.

The RAN 110 can include one or more AN nodes or RAN nodes 111a and 111b (collectively referred to as “RAN nodes 111” or “RAN node 111”) that enable the connections 103 and 104. As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can comprise ground stations (e.g., terrestrial access points) or satellite stations providing coverage within a geographic area (e.g., a cell). As used herein, the term “NG RAN node” or the like may refer to a RAN node 111 that operates in an NR or 5G system 100 (for example, a gNB), and the term “E-UTRAN node” or the like may refer to a RAN node 111 that operates in an LTE or 4G system 100 (e.g., an eNB). According to various examples, the RAN nodes 111 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

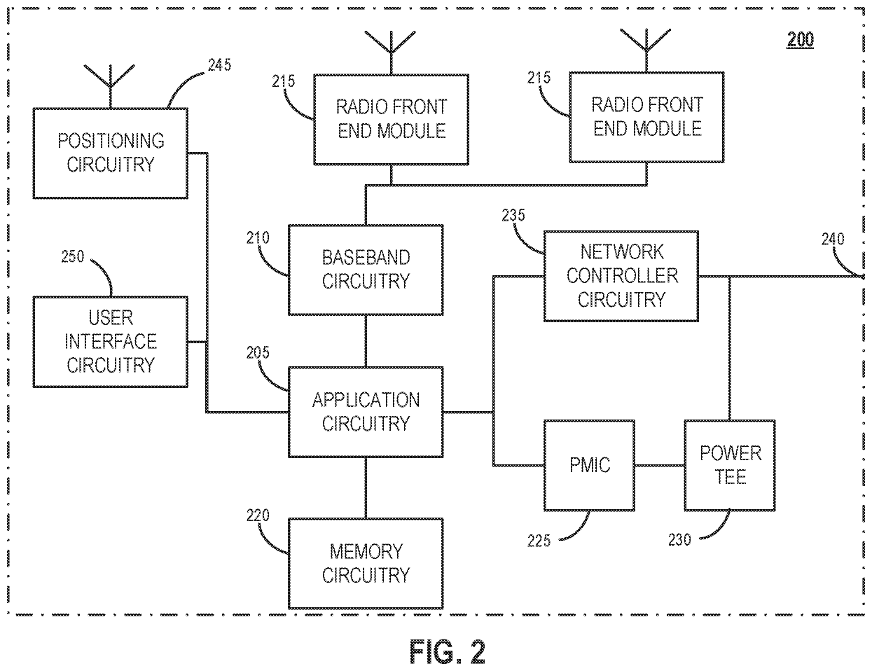

In some examples, all or parts of the RAN nodes 111 may be implemented as one or more software entities running on server computers as part of a virtual network, which may be referred to as a CRAN and/or a virtual baseband unit pool (vBBUP). In these examples, the CRAN or vBBUP may implement a RAN function split, such as a PDCP split wherein RRC and PDCP layers are operated by the CRAN/vBBUP and other L2 protocol entities are operated by individual RAN nodes 111; a MAC/PHY split wherein RRC, PDCP, RLC, and MAC layers are operated by the CRAN/vBBUP and the PHY layer is operated by individual RAN nodes 111; or a “lower PHY” split wherein RRC, PDCP, RLC, MAC layers and upper portions of the PHY layer are operated by the CRAN/vBBUP and lower portions of the PHY layer are operated by individual RAN nodes 111. This virtualized framework allows the freed-up processor cores of the RAN nodes 111 to perform other virtualized applications. In some examples, an individual RAN node 111 may represent individual gNB-DUs that are connected to a gNB-CU via individual F1 interfaces (not shown by FIG. 1). In some examples, the gNB-DUs may include one or more remote radio heads or RFEMs (see, e.g., FIG. 2), and the gNB-CU may be operated by a server that is located in the RAN 110 (not shown) or by a server pool in a similar manner as the CRAN/vBBUP. Additionally or alternatively, one or more of the RAN nodes 111 may be next generation eNBs (ng-eNBs), which are RAN nodes that provide E-UTRA user plane and control plane protocol terminations toward the UEs 101, and are connected to a 5GC via an NG interface (discussed infra).

Any of the RAN nodes 111 can terminate the air interface protocol and can be the first point of contact for the UEs 101. In some examples, any of the RAN nodes 111 can fulfill various logical functions for the RAN 110 including, but not limited to, radio network controller (RNC) functions such as radio bearer management, uplink and downlink dynamic radio resource management and data packet scheduling, and mobility management.

In some examples, the UEs 101 can be configured to communicate using OFDM communication signals with each other or with any of the RAN nodes 111 over a multicarrier communication channel in accordance with various communication techniques, such as, but not limited to, an OFDMA communication technique (e.g., for downlink communications) or a SC-FDMA communication technique (e.g., for uplink and ProSe or sidelink communications), although the scope of the examples is not limited in this respect. The OFDM signals can comprise a plurality of orthogonal subcarriers.

In some examples, a downlink resource grid can be used for downlink transmissions from any of the RAN nodes 111 to the UEs 101, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

According to various examples, the UEs 101 and the RAN nodes 111 communicate data (for example, transmit and receive) data over a licensed medium (also referred to as the “licensed spectrum” and/or the “licensed band”) and an unlicensed shared medium (also referred to as the “unlicensed spectrum” and/or the “unlicensed band”). The licensed spectrum may include channels that operate in the frequency range of approximately 400 MHz to approximately 3.8 GHz, whereas the unlicensed spectrum may include the S GHz band. NR in the unlicensed spectrum may be referred to as NR-U, and LTE in an unlicensed spectrum may be referred to as LTE-U, licensed assisted access (LAA), or MulteFire. To operate in the unlicensed spectrum, the UEs 101 and the RAN nodes 111 may operate using LAA, eLAA, and/or feLAA mechanisms. In some examples, the UEs 101 and the RAN nodes 111 may perform one or more known medium-sensing operations and/or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

In some examples, a physical downlink shared channel (PDSCH) carries user data and higher-layer signaling to the UEs 101. In some examples, a physical downlink control channel (PDCCH) carries information about the transport format and resource allocations related to the PDSCH channel, among other things. It may also inform the UEs 101 about the transport format, resource allocation, and HARQ information related to the uplink shared channel. Typically, downlink scheduling (assigning control and shared channel resource blocks to the UE 101b within a cell) may be performed at any of the RAN nodes 111 based on channel quality information fed back from any of the UEs 101. The downlink resource assignment information may be sent on the PDCCH used for (e.g., assigned to) each of the UEs 101.

The PDCCH uses CCEs to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as REGs. Four Quadrature Phase Shift Keying (QPSK) symbols may be mapped to each REG. The PDCCH can be transmitted using one or more CCEs, depending on the size of the DCI and the channel condition. There can be four or more different PDCCH formats defined in LTE with different numbers of CCEs (e.g., aggregation level, L=1, 2, 4, or 8).

Some examples may use concepts for resource allocation for control channel information that are an extension of the above-described concepts. For example, some examples may utilize an EPDCCH that uses PDSCH resources for control information transmission. The EPDCCH may be transmitted using one or more ECCEs. Similar to above, each ECCE may correspond to nine sets of four physical resource elements known as an EREGs. An ECCE may have other numbers of EREGs in some situations.

The RAN nodes 111 may be configured to communicate with one another via interface 112. In examples where the system 100 is an LTE system, the interface 112 may be an X2 interface 112. The X2 interface may be defined between two or more RAN nodes 111 (e.g., two or more eNBs and the like) that connect to EPC 120, and/or between two eNBs connecting to EPC 120. In some examples, the X2 interface may include an X2 user plane interface (X2-U) and an X2 control plane interface (X2-C). The X2-U may provide flow control mechanisms for user data packets transferred over the X2 interface, and may be used to communicate information about the delivery of user data between eNBs. For example, the X2-U may provide specific sequence number information for user data transferred from a MeNB to an SeNB; information about successful in sequence delivery of PDCP PDUs to a UE 101 from an SeNB for user data; information of PDCP PDUs that were not delivered to a UE 101; information about a current minimum desired buffer size at the SeNB for transmitting to the UE user data; and the like. The X2-C may provide intra-LTE access mobility functionality, including context transfers from source to target eNBs, user plane transport control, etc; load management functionality; as well as inter-cell interference coordination functionality.

In examples where the system 100 is a 5G or NR system, the interface 112 may be an Xn interface 112. The Xn interface is defined between two or more RAN nodes 111 (e.g., two or more gNBs and the like) that connect to 5GC 120, between a RAN node 111 (e.g., a gNB) connecting to 5GC 120 and an eNB, and/or between two eNBs connecting to 5GC 120. In some examples, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 101 in a connected mode (e.g., CM-CONNECTED) including functionality to manage the UE mobility for connected mode between one or more RAN nodes 111. The mobility support may include context transfer from an old (source) serving RAN node 111 to new (target) serving RAN node 111; and control of user plane tunnels between old (source) serving RAN node 111 to new (target) serving RAN node 111. A protocol stack of the Xn-U may include a transport network layer built on Internet Protocol (IP) transport layer, and a GTP—U layer on top of a UDP and/or IP layer(s) to carry user plane PDUs. The Xn-C protocol stack may include an application layer signaling protocol (referred to as Xn Application Protocol (Xn-AP)) and a transport network layer that is built on SCTP. The SCTP may be on top of an IP layer, and may provide the guaranteed delivery of application layer messages. In the transport IP layer, point-to-point transmission is used to deliver the signaling PDUs. In some examples, the Xn-U protocol stack and/or the Xn-C protocol stack may be same or similar to the user plane and/or control plane protocol stack(s) shown and described herein.

The RAN 110 is shown to be communicatively coupled to a core network-in this example, core network (CN) 120. The CN 120 may comprise a plurality of network elements 122, which are configured to offer various data and telecommunications services to customers/subscribers (e.g., users of UEs 101) who are connected to the CN 120 via the RAN 110. The components of the CN 120 may be implemented in one physical node or separate physical nodes including components to read and execute instructions from a machine-readable or computer-readable medium (e.g., a non-transitory machine-readable storage medium). In some examples, NFV may be utilized to virtualize any or all of the above-described network node functions via executable instructions stored in one or more computer-readable storage mediums (described in further detail below). A logical instantiation of the CN 120 may be referred to as a network slice, and a logical instantiation of a portion of the CN 120 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

Generally, the application server 130 may be an element offering applications that use IP bearer resources with the core network (e.g., UMTS PS domain, LTE PS data services, etc.). The application server 130 can also be configured to support one or more communication services (e.g., VoIP sessions, PTT sessions, group communication sessions, social networking services, etc.) for the UEs 101 via the EPC 120.

In some examples, the CN 120 may be a 5GC (referred to as “5GC 120” or the like), and the RAN 110 may be connected with the CN 120 via an NG interface 113. In some examples, the NG interface 113 may be split into two parts, an NG user plane (NG-U) interface 114, which carries traffic data between the RAN nodes 111 and a UPF, and the S1 control plane (NG-C) interface 115, which is a signaling interface between the RAN nodes 111 and AMFs.

In some examples, the CN 120 may be a 5G CN (referred to as “5GC 120” or the like), while in other examples, the CN 120 may be an EPC). Where CN 120 is an EPC (referred to as “EPC 120” or the like), the RAN 110 may be connected with the CN 120 via an S1 interface 113. In some examples, the S1 interface 113 may be split into two parts, an S1 user plane (S1-U) interface 114, which carries traffic data between the RAN nodes 111 and the S-GW, and the S1-MME interface 115, which is a signaling interface between the RAN nodes 111 and MMEs.

FIG. 2 illustrates an example of infrastructure equipment 200 in accordance with various examples. The infrastructure equipment 200 (or “system 200”) may be implemented as a base station, radio head, RAN node such as the RAN nodes 111 and/or AP 106 shown and described previously, application server(s) 130, and/or any other element/device discussed herein. In other examples, the system 200 could be implemented in or by a UE.

The system 200 includes application circuitry 205, baseband circuitry 210, one or more radio front end modules (RFEMs) 215, memory circuitry 220, power management integrated circuitry (PMIC) 225, power tee circuitry 230, network controller circuitry 235, network interface connector 240, satellite positioning circuitry 245, and user interface 250. In some examples, the device 200 may include additional elements such as, for example, memory/storage, display, camera, sensor, or input/output (I/O) interface. In other examples, the components described below may be included in more than one device. For example, said circuitries may be separately included in more than one device for CRAN, vBBU, or other like implementations.

Application circuitry 205 includes circuitry such as, but not limited to one or more processors (or processor cores), cache memory, and one or more of low drop-out voltage regulators (LDOs), interrupt controllers, serial interfaces such as SPI, I2C or universal programmable serial interface module, real time clock (RTC), timer-counters including interval and watchdog timers, general purpose input/output (I/O or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry 205 may be coupled with or may include memory/storage elements and may be configured to execute instructions stored in the memory/storage to enable various applications or operating systems to run on the system 200. In some examples, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 205 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more FPGAs, one or more PLDs, one or more ASICs, one or more microprocessors or controllers, or any suitable combination thereof. In some examples, the application circuitry 205 may comprise, or may be, a special-purpose processor/controller to operate according to the various examples herein. As examples, the processor(s) of application circuitry 205 may include one or more may include one or more Apple A-series processors, Intel Pentium®, Core®, or Xeon® processor(s); Advanced Micro Devices (AMD) Ryzen® processor(s), Accelerated Processing Units (APUs), or Epyc® processors; ARM-based processor(s) licensed from ARM Holdings, Ltd. Such as the ARM Cortex-A family of processors and the ThunderX2® provided by Cavium™, Inc.; a MIPS-based design from MIPS Technologies, Inc. Such as MIPS Warrior P-class processors; and/or the like. In some examples, the system 200 may not utilize application circuitry 205, and instead may include a special-purpose processor/controller to process IP data received from an EPC or 5GC, for example.

In some examples, the application circuitry 205 may include one or more hardware accelerators, which may be microprocessors, programmable processing devices, or the like. The one or more hardware accelerators may include, for example, computer vision (CV) and/or deep learning (DL) accelerators. As examples, the programmable processing devices may be one or more a field-programmable devices (FPDs) such as field-programmable gate arrays (FPGAs) and the like; programmable logic devices (PLDs) such as complex PLDs (CPLDs), high-capacity PLDs (HCPLDs), and the like; ASICs such as structured ASICs and the like; programmable SoCs (PSoCs); and the like. In some examples, the circuitry of application circuitry 205 may comprise logic blocks or logic fabric, and other interconnected resources that may be programmed to perform various functions, such as the procedures, methods, functions, etc. Of the various examples discussed herein. In such examples, the circuitry of application circuitry 205 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. In look-up-tables (LUTs) and the like.

The baseband circuitry 210 may include circuitry and/or control logic configured to carry out various radio/network protocol and radio control functions that enable communication with one or more radio networks via the RF circuitry. In some examples, the baseband circuitry 210 may be implemented, for example, as a solder-down substrate including one or more integrated circuits, a single packaged integrated circuit soldered to a main circuit board or a multi-chip module containing two or more integrated circuits.

User interface circuitry 250 may include one or more user interfaces designed to enable user interaction with the system 200 or peripheral component interfaces designed to enable peripheral component interaction with the system 200. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component interfaces may include, but are not limited to, a nonvolatile memory port, a universal serial bus (USB) port, an audio jack, a power supply interface, etc.

The radio front end modules (RFEMs) 215 may comprise a millimeter wave (mmWave) RFEM and one or more sub-mmWave radio frequency integrated circuits (RFICs). In some examples, the one or more sub-mm Wave RFICs may be physically separated from the mmWave RFEM. The RFICs may include connections to one or more antennas or antenna arrays, and the RFEM may be connected to multiple antennas. In some examples, both mmWave and sub-mmWave radio functions may be implemented in the same physical RFEM 215, which incorporates both mm Wave antennas and sub-mm Wave.

The memory circuitry 220 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magnetoresistive random access memory (MRAM), etc., and may incorporate the three-dimensional (3D) cross-point (XPOINT) memories from Intel® and Micron® Memory circuitry 220 may be implemented as one or more of solder down packaged integrated circuits, socketed memory modules and plug-in memory cards.

The PMIC 225 may include voltage regulators, surge protectors, power alarm detection circuitry, and one or more backup power sources such as a battery or capacitor. The power alarm detection circuitry may detect one or more of brown out (under-voltage) and surge (over-voltage) conditions. The power tee circuitry 230 may provide for electrical power drawn from a network cable to provide both power supply and data connectivity to the infrastructure equipment 200 using a single cable.

The network controller circuitry 235 may provide connectivity to a network using a standard network interface protocol such as Ethernet, Ethernet over GRE Tunnels, Ethernet over Multiprotocol Label Switching (MPLS), or some other suitable protocol. Network connectivity may be provided to/from the infrastructure equipment 200 via network interface connector 240 using a physical connection, which may be electrical (commonly referred to as a “copper interconnect”), optical, or wireless. The network controller circuitry 235 may include one or more dedicated processors and/or FPGAs to communicate using one or more of the aforementioned protocols. In some examples, the network controller circuitry 235 may include multiple controllers to provide connectivity to other networks using the same or different protocols.

The positioning circuitry 245 includes circuitry to receive and decode signals transmitted/broadcasted by a positioning network of a global navigation satellite system (GNSS). Examples of navigation satellite constellations (or GNSS) include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS), etc.), or the like. The positioning circuitry 245 comprises various hardware elements (e.g., including hardware devices such as switches, filters, amplifiers, antenna elements, and the like to facilitate OTA communications) to communicate with components of a positioning network, such as navigation satellite constellation nodes. In some examples, the positioning circuitry 245 may include a Micro-Technology for Positioning, Navigation, and Timing (Micro-PNT) IC that uses a master timing clock to perform position tracking/estimation without GNSS assistance. The positioning circuitry 245 may also be part of, or interact with, the baseband circuitry 210 and/or RFEMs 215 to communicate with the nodes and components of the positioning network. The positioning circuitry 245 may also provide position data and/or time data to the application circuitry 205, which may use the data to synchronize operations with various infrastructure (e.g., RAN nodes 111, etc.), or the like.

The components shown by FIG. 2 may communicate with one another using interface circuitry, which may include any number of bus and/or interconnect (IX) technologies such as industry standard architecture (ISA), extended ISA (EISA), peripheral component interconnect (PCI), peripheral component interconnect extended (PCIx), PCI express (PCIe), or any number of other technologies. The bus/IX may be a proprietary bus, for example, used in a SoC based system. Other bus/IX systems may be included, such as an I2C interface, an SPI interface, point to point interfaces, and a power bus, among others.

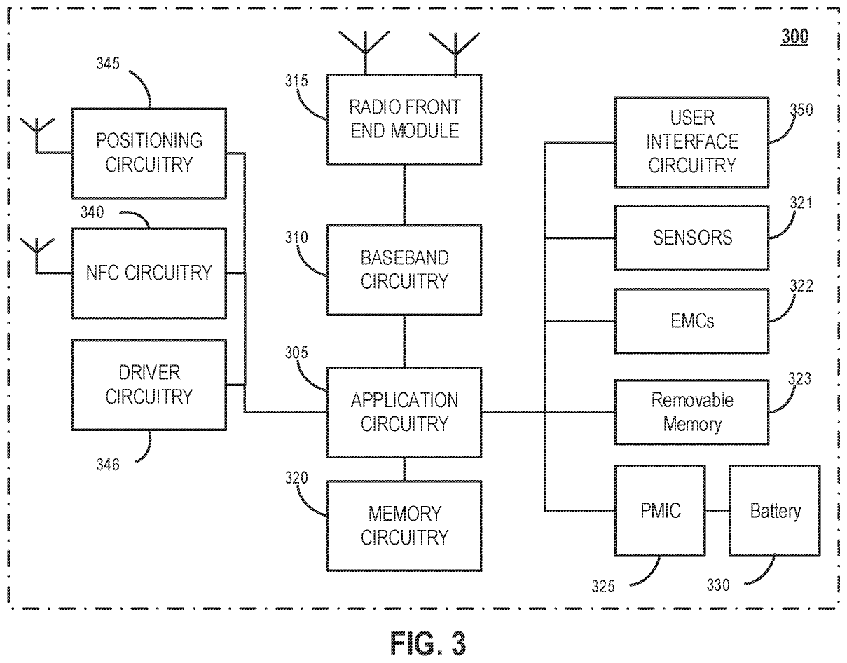

FIG. 3 illustrates an example of a platform 300 (or “device 300”) in accordance with various examples. In some examples, the computer platform 300 may be suitable for use as UEs 101, application servers 130, and/or any other element/device discussed herein. The platform 300 may include any combinations of the components shown in the example. The components of platform 300 may be implemented as integrated circuits (ICs), portions thereof, discrete electronic devices, or other modules, logic, hardware, software, firmware, or a combination thereof adapted in the computer platform 300, or as components otherwise incorporated within a chassis of a larger system. The block diagram of FIG. 3 is intended to show a high level view of components of the computer platform 300. However, some of the components shown may be omitted, additional components may be present, and different arrangement of the components shown may occur in other implementations.

Application circuitry 305 includes circuitry such as, but not limited to one or more processors (or processor cores), cache memory, and one or more of LDOs, interrupt controllers, serial interfaces such as SPI, I2C or universal programmable serial interface module, RTC, timer-counters including interval and watchdog timers, general purpose I/O, memory card controllers such as SD MMC or similar, USB interfaces, MIPI interfaces, and JTAG test access ports. The processors (or cores) of the application circuitry 305 may be coupled with or may include memory/storage elements and may be configured to execute instructions stored in the memory/storage to enable various applications or operating systems to run on the system 300. In some examples, the memory/storage elements may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 205 may include, for example, one or more processor cores, one or more application processors, one or more GPUs, one or more RISC processors, one or more ARM processors, one or more CISC processors, one or more DSP, one or more FPGAs, one or more PLDs, one or more ASICs, one or more microprocessors or controllers, a multithreaded processor, an ultra-low voltage processor, an embedded processor, some other known processing element, or any suitable combination thereof. In some examples, the application circuitry 205 may comprise, or may be, a special-purpose processor/controller to operate according to the various examples herein.

As examples, the processor(s) of application circuitry 305 may include an Apple A-series processor. The processors of the application circuitry 305 may also be one or more of an Intel® Architecture Core™ based processor, such as a Quark™, an Atom™, an i3, an i5, an i7, or an MCU-class processor, or another such processor available from Intel® Corporation, Santa Clara, CA; Advanced Micro Devices (AMD) Ryzen® processor(s) or Accelerated Processing Units (APUs); Snapdragon™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; or the like. In some examples, the application circuitry 305 may be a part of a system on a chip (SoC) in which the application circuitry 305 and other components are formed into a single integrated circuit.

Additionally or alternatively, application circuitry 305 may include circuitry such as, but not limited to, one or more a field-programmable devices (FPDs) such as FPGAs and the like; programmable logic devices (PLDs) such as complex PLDs (CPLDs), high-capacity PLDs (HCPLDs), and the like; ASICs such as structured ASICs and the like; programmable SoCs (PSoCs); and the like. In such examples, the circuitry of application circuitry 305 may comprise logic blocks or logic fabric, and other interconnected resources that may be programmed to perform various functions, such as the procedures, methods, functions, etc. Of the various examples discussed herein. In such examples, the circuitry of application circuitry 305 may include memory cells (e.g., erasable programmable read-only memory (EPROM), electrically erasable programmable read-only memory (EEPROM), flash memory, static memory (e.g., static random access memory (SRAM), anti-fuses, etc.)) used to store logic blocks, logic fabric, data, etc. In look-up tables (LUTs) and the like.

The baseband circuitry 310 includes circuitry and/or control logic configured to carry out various radio/network protocol and radio control functions that enable communication with one or more radio networks via the RF circuitry. In some examples, the baseband circuitry 310 may be implemented, for example, as a solder-down substrate including one or more integrated circuits, a single packaged integrated circuit soldered to a main circuit board or a multi-chip module containing two or more integrated circuits.

The RFEMs 315 may comprise a millimeter wave (mmWave) RFEM and one or more sub-mm Wave radio frequency integrated circuits (RFICs). In some examples, the one or more sub-mmWave RFICs may be physically separated from the mm Wave RFEM. The RFICs may include connections to one or more antennas or antenna arrays, and the RFEM may be connected to multiple antennas. In some examples, both mmWave and sub-mm Wave radio functions may be implemented in the same physical RFEM 315, which incorporates both mm Wave antennas and sub-mmWave.

The memory circuitry 320 may include any number and type of memory devices used to provide for a given amount of system memory. As examples, the memory circuitry 320 may include one or more of volatile memory including random access memory (RAM), dynamic RAM (DRAM) and/or synchronous dynamic RAM (SDRAM), and nonvolatile memory (NVM) including high-speed electrically erasable memory (commonly referred to as Flash memory), phase change random access memory (PRAM), magnetoresistive random access memory (MRAM), etc. The memory circuitry 320 may be developed in accordance with a Joint Electron Devices Engineering Council (JEDEC) low power double data rate (LPDDR)-based design, such as LPDDR2, LPDDR3, LPDDR4, or the like. Memory circuitry 320 may be implemented as one or more of solder down packaged integrated circuits, single die package (SDP), dual die package (DDP) or quad die package (Q17P), socketed memory modules, dual inline memory modules (DIMMs) including microDIMMs or MiniDIMMs, and/or soldered onto a motherboard via a ball grid array (BGA). In low power implementations, the memory circuitry 320 may be on-die memory or registers associated with the application circuitry 305. To provide for persistent storage of information such as data, applications, operating systems and so forth, memory circuitry 320 may include one or more mass storage devices, which may include, inter alia, a solid state disk drive (SSDD), hard disk drive (HDD), a micro HDD, resistance change memories, phase change memories, holographic memories, or chemical memories, among others. For example, the computer platform 300 may incorporate the three-dimensional (3D) cross-point (XPOINT) memories from Intel® and Micron®.

Removable memory circuitry 323 may include devices, circuitry, enclosures/housings, ports or receptacles, etc. Used to couple portable data storage devices with the platform 300. These portable data storage devices may be used for mass storage purposes, and may include, for example, flash memory cards (e.g., Secure Digital (SD) cards, microSD cards, XD picture cards, and the like), and USB flash drives, optical discs, external HDDs, and the like.

The platform 300 may also include interface circuitry (not shown) that is used to connect external devices with the platform 300. The external devices connected to the platform 300 via the interface circuitry include sensor circuitry 321 and electro-mechanical components (EMCs) 322, as well as removable memory devices coupled to removable memory circuitry 323.

The sensor circuitry 321 include devices, modules, or subsystems whose purpose is to detect events or changes in its environment and send the information (sensor data) about the detected events to some other a device, module, subsystem, etc. Examples of such sensors include, inter alia, inertia measurement units (IMUs) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors (e.g., thermistors); pressure sensors; barometric pressure sensors; gravimeters; altimeters; image capture devices (e.g., cameras or lensless apertures); light detection and ranging (LiDAR) sensors; proximity sensors (e.g., infrared radiation detector and the like), depth sensors, ambient light sensors, ultrasonic transceivers; microphones or other like audio capture devices; etc.

EMCs 322 include devices, modules, or subsystems whose purpose is to enable platform 300 to change its state, position, and/or orientation, or move or control a mechanism or (sub) system. Additionally, EMCs 322 may be configured to generate and send messages/signaling to other components of the platform 300 to indicate a current state of the EMCs 322. Examples of the EMCs 322 include one or more power switches, relays including electromechanical relays (EMRs) and/or solid state relays (SSRs), actuators (e.g., valve actuators, etc.), an audible sound generator, a visual warning device, motors (e.g., DC motors, stepper motors, etc.), wheels, thrusters, propellers, claws, clamps, hooks, and/or other like electro-mechanical components. In some examples, platform 300 is configured to operate one or more EMCs 322 based on one or more captured events and/or instructions or control signals received from a service provider and/or various clients.

In some examples, the interface circuitry may connect the platform 300 with positioning circuitry 345. The positioning circuitry 345 includes circuitry to receive and decode signals transmitted/broadcasted by a positioning network of a GNSS. Examples of navigation satellite constellations (or GNSS) include United States' GPS, Russia's GLONASS, the European Union's Galileo system, China's BeiDou Navigation Satellite System, a regional navigation system or GNSS augmentation system (e.g., NAVIC), Japan's QZSS, France's DORIS, etc.), or the like. The positioning circuitry 345 comprises various hardware elements (e.g., including hardware devices such as switches, filters, amplifiers, antenna elements, and the like to facilitate OTA communications) to communicate with components of a positioning network, such as navigation satellite constellation nodes. In some examples, the positioning circuitry 345 may include a Micro-PNT IC that uses a master timing clock to perform position tracking/estimation without GNSS assistance. The positioning circuitry 345 may also be part of, or interact with, the baseband circuitry 210 and/or RFEMs 315 to communicate with the nodes and components of the positioning network. The positioning circuitry 345 may also provide position data and/or time data to the application circuitry 305, which may use the data to synchronize operations with various infrastructure (e.g., radio base stations), for turn-by-turn navigation applications, or the like

In some examples, the interface circuitry may connect the platform 300 with Near-Field Communication (NFC) circuitry 340. NFC circuitry 340 is configured to provide contactless, short-range communications based on radio frequency identification (RFID) standards, wherein magnetic field induction is used to enable communication between NFC circuitry 340 and NFC-enabled devices external to the platform 300 (e.g., an “NFC touchpoint”). NFC circuitry 340 comprises an NFC controller coupled with an antenna element and a processor coupled with the NFC controller. The NFC controller may be a chip/IC providing NFC functionalities to the NFC circuitry 340 by executing NFC controller firmware and an NFC stack. The NFC stack may be executed by the processor to control the NFC controller, and the NFC controller firmware may be executed by the NFC controller to control the antenna element to emit short-range RF signals. The RF signals may power a passive NFC tag (e.g., a microchip embedded in a sticker or wristband) to transmit stored data to the NFC circuitry 340, or initiate data transfer between the NFC circuitry 340 and another active NFC device (e.g., a smartphone or an NFC-enabled POS terminal) that is proximate to the platform 300.

The driver circuitry 346 may include software and hardware elements that operate to control particular devices that are embedded in the platform 300, attached to the platform 300, or otherwise communicatively coupled with the platform 300. The driver circuitry 346 may include individual drivers allowing other components of the platform 300 to interact with or control various input/output (I/O) devices that may be present within, or connected to, the platform 300. For example, driver circuitry 346 may include a display driver to control and allow access to a display device, a touchscreen driver to control and allow access to a touchscreen interface of the platform 300, sensor drivers to obtain sensor readings of sensor circuitry 321 and control and allow access to sensor circuitry 321, EMC drivers to obtain actuator positions of the EMCs 322 and/or control and allow access to the EMCs 322, a camera driver to control and allow access to an embedded image capture device, audio drivers to control and allow access to one or more audio devices.

The power management integrated circuitry (PMIC) 325 (also referred to as “power management circuitry 325”) may manage power provided to various components of the platform 300. In particular, with respect to the baseband circuitry 310, the PMIC 325 may control power-source selection, voltage scaling, battery charging, or DC-to-DC conversion. The PMIC 325 may often be included when the platform 300 is capable of being powered by a battery 330, for example, when the device is included in a UE 101.

A battery 330 may power the platform 300, although in some examples the platform 300 may be mounted deployed in a fixed location, and may have a power supply coupled to an electrical grid. The battery 330 may be a lithium ion battery, a metal-air battery, such as a zinc-air battery, an aluminum-air battery, a lithium-air battery, and the like. In some examples, such as in V2X applications, the battery 330 may be a typical lead-acid automotive battery.

User interface circuitry 350 includes various input/output (I/O) devices present within, or connected to, the platform 300, and includes one or more user interfaces designed to enable user interaction with the platform 300 and/or peripheral component interfaces designed to enable peripheral component interaction with the platform 300. The user interface circuitry 350 includes input device circuitry and output device circuitry. Input device circuitry includes any physical or virtual means for accepting an input including, inter alia, one or more physical or virtual buttons (e.g., a reset button), a physical keyboard, keypad, mouse, touchpad, touchscreen, microphones, scanner, headset, and/or the like. The output device circuitry includes any physical or virtual means for showing information or otherwise conveying information, such as sensor readings, actuator position(s), or other like information. Output device circuitry may include any number and/or combinations of audio or visual display, including, inter alia, one or more simple visual outputs/indicators (e.g., binary status indicators (e.g., light emitting diodes (LEDs)) and multi-character visual outputs, or more complex outputs such as display devices or touchscreens (e.g., Liquid Chrystal Displays (LCD), LED displays, quantum dot displays, projectors, etc.), with the output of characters, graphics, multimedia objects, and the like being generated or produced from the operation of the platform 300. The output device circuitry may also include speakers or other audio emitting devices, printer(s), and/or the like. In some examples, the sensor circuitry 321 may be used as the input device circuitry (e.g., an image capture device, motion capture device, or the like) and one or more EMCs may be used as the output device circuitry (e.g., an actuator to provide haptic feedback or the like). In another example, NFC circuitry comprising an NFC controller coupled with an antenna element and a processing device may be included to read electronic tags and/or connect with another NFC-enabled device. Peripheral component interfaces may include, but are not limited to, a non-volatile memory port, a USB port, an audio jack, a power supply interface, etc.

Although not shown, the components of platform 300 may communicate with one another using a suitable bus or interconnect (IX) technology, which may include any number of technologies, including ISA, EISA, PCI, PCIx, PCIe, a Time-Trigger Protocol (TTP) system, a FlexRay system, or any number of other technologies. The bus/IX may be a proprietary bus/IX, for example, used in a SoC based system. Other bus/IX systems may be included, such as an I2C interface, an SPI interface, point-to-point interfaces, and a power bus, among others.

As discussed above, a device (e.g., a UE 101 or device 300) can support multiple USIMs from the same or different service providers to allow a user to communicate over a network associated with each USIM. Currently, multi-USIM (MUSIM) operation is supported in an implementation-specific manner, with each implementation having different behaviors. Since MUSIM devices share radio and baseband resources across USIMs, the lack of standardization for MUSIM can lead to various issues. For example, while communicating with a first system associated with a first USIM, the MUSIM device may occasionally need to monitor communications from a second system associated with a second USIM in order to read system information, perform signal measurements, or respond to paging, which can cause interruptions to the ongoing service with the first system. As another example, if the MUSIM device is unable to suspend ongoing activity with the first system when responding to a page from the second system, the MUSIM device may need to drop the connection (e.g., RRC connection) with the first system to stop activity on the first system, thereby degrading the user experience and wasting network resources. Similarly, when a MUSIM device receives a page on the second system, it may not know how to respond, in absence of additional information about the service type that triggered the page. As another example, paging collisions due to the same wireless device identifier (e.g., IMSI) value being used for communications associated with both USIMs can lead to missed pages.

To foster more predictable MUSIM device behavior and enhance MUSIM performance, the 3GPP has set out to standardize aspects of MUSIM operation. In particular, the 3GPP has set out to define (e.g., in 3GPP TS 22.101, TS 22.261, and TS 22.278, among others) operating procedures for various MUSIM-related features, including NAS Connection Release, Paging cause Indication for Voice, Rejection of Paging Request, Paging Restrictions, and Paging Timing Collision Control, among others. For NAS Connection Release, it was agreed (e.g., in 3GPP TS 23.501 and TS 23.502) that a NAS connection may be released and a MUSIM device can transition to an idle state on one USIM due to activity on another USIM. For Paging cause Indication for Voice, it was agreed (e.g., in 3GPP TS 23.501) that the network would provide an indication for voice service in a paging message. For Rejection of Paging Request, it was agreed (e.g., in 3GPP TS 23.501 and TS 23.502) that a MUSIM device can indicate to the network that it is unable to respond to paging for a particular USIM (or USIMs) and can request to be released to an idle mode. For Paging Restrictions, it was agreed (e.g., in 3GPP TS 23.501) that a MUSIM device and the network can support paging restrictions including all paging restricted, all paging restricted except paging for voice service (e.g., MMTel voice or CS domain voice), all paging restricted except for certain Public Data Network (PDN) or Packet Data Unit (PDU) connection(s), and all paging restricted except for certain PDN/PDU connection(s) and voice service (e.g., MMTel voice or CS domain voice), among others. For Paging Timing Collision Control, it was agreed (e.g., in 3GPP TS 23.501) that a MUSIM device and the network can negotiate an IMSI offset to avoid paging collisions across different USIMs.

In general, MUSIM devices and network(s) can negotiate their MUSIM capabilities, including capabilities for the above-noted features, during the Attach/Tracking Area Update (TAU) and Service Request procedures in Evolved Packet System (EPS) (see, e.g., 3GPP TS 24.301), and during the Registration and Service Request procedures in 5GS (see, e.g., 3GPP TS 24.501). Specifically, in EPS, a MUSIM device can specify its capabilities in a UE network capability IE, and the network can specify its capabilities in an EPS network feature support IE. In 5GS, a MUSIM device can specify its capabilities in a 5G Mobility Management (5GMM) capability IE, and the network can specify its capabilities in a 5GS network feature support IE.

The technology described here facilitates MUSIM operation by enabling a MUSIM device to set and retrieve values of MUSIM-related parameters (e.g., parameters related to the MUSIM operation of the device). In particular, new attention (AT) commands are defined that allow a terminal equipment (TE) of a MUSIM device to control the function of a mobile termination (MT) of the device in order to set and/or retrieve parameter values for various MUSIM features, including NAS Connection Release, Paging cause Indication for Voice, Rejection of Paging Request, Paging Restrictions, and Paging Timing Collision Control. By defining a standard means by which a MUSIM device can set and/or retrieve values of MUSIM-related parameters, the technology improves MUSIM operation by, for example, reducing collisions among communications associated with separate USIMs, preventing interruptions that disrupt the user experience, and enabling more efficient allocation of device and network resources.

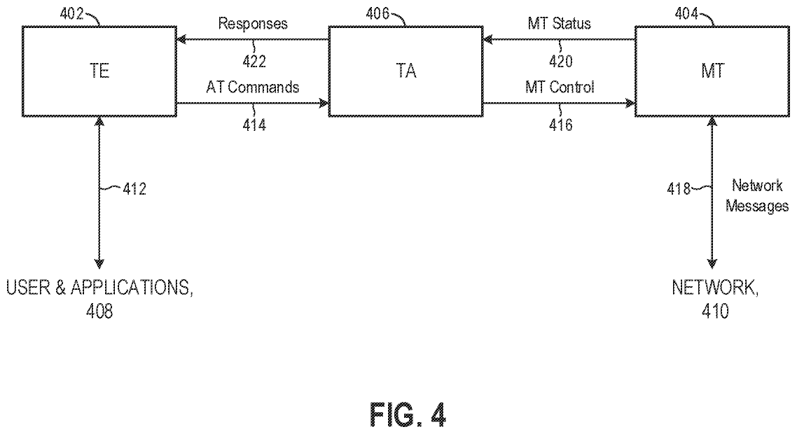

FIG. 4 illustrates an example architecture of a MUSIM device 400 in accordance with an aspect of the present disclosure. In this example, the device 400 includes a terminal equipment (TE) 402 communicatively coupled with a mobile termination (MT) 404 via a terminal adapter (TA) 406. In some examples, the TE 402 includes application circuitry (e.g., the application circuitry 305 of the device 300 in FIG. 3), and the MT 404 includes baseband circuitry (e.g., the baseband circuitry 310 of the device 300 of FIG. 3).

The abstract architecture of UE 400 can be physically implemented in various ways. For instance, in some examples, the TE 402, the MT 404, and the TA 406 can be implemented as three separate entities. In some examples, the TA 406 is integrated under the MT 404 cover, and the TE 402 is implemented as a separate entity. In some examples, the TA 406 is integrated under the TE 402 cover, and the MT 404 is implemented as a separate entity. In some examples, the TA 406 and the MT 404 are integrated under the TE 402 cover as a single entity.

In operation, one or more applications 408 executing on the device 400 may utilize a MUSIM-related feature. Accordingly, the application(s) 408 may transmit data to the TE indicating, for example, a value for a MUSIM-related parameter, a request to read a MUSIM-related parameter, or the like (shown as operation 412). In response, the TE 402 can generate and transmit one or more AT commands to the TA 406 (shown as operation 414), which are then parsed and transmitted as MT control commands to control the MT 404 (shown as operation 416).

In general, the AT commands can include, for example, general commands, call control commands, network service related commands, MT control and status commands, MT errors result codes, commands for packet domain, commands for voice group call service (VGCS) and voice broadcast service (VBS), and commands for the USIM Application Toolkit, among other commands described herein. In some examples, the AT commands set and/or retrieve values for one or more MUSIM-related parameters, such as values for parameters related to handling of NAS connections with a CN or RAN associated with a particular USIM, values for parameters related to incoming paging from a CN or RAN associated with a particular USIM, values for parameters related to an IMSI used by a CN or RAN (or MME or AMF) for a particular USIM, or combinations of them, among others.

The MT 404 may transmit and receive data to and from one or more networks 410 associated with one or more particular USIM(s) of the device 400 (shown as operation 418). For example, the MT 404 may send a request to a network 410 (e.g., a network node, such as MME in EPS or an AMF in 5GS) associated with a particular USIM to indicate to the network whether to release a NAS connection, restrict or reject paging, negotiate an IMSI offset, and the like. The MT 404 can then send MT status messages to the TA 406 based on the response received from the network 410 (shown as operation 420), which the TA 406 sends to the TE 402 as responses to the AT commands (shown as operation 422). Data from these responses may then be transmitted to the one or more applications 408, stored in memory (or another data storage medium), or both. In this manner, the AT commands described here provide a way for the TE 402 to control the MT 404 in order to set and/or retrieve values of MUSIM-related parameters.

The following discussion provides exemplary command/response tables for new MUSIM AT commands in accordance with an aspect of the present disclosure. These AT commands allow for the TE 402 of the MUSIM device 400 to communicate with the MT 404 to set and/or retrieve values of MUSIM-related parameters based on, for example, UE capabilities. The command/response tables described below may be used in a variety of cellular communications standards, such as 3GPP LTE and/or NR standards. In some examples, some or all of the command/response tables can be incorporated into one or more of the 3GPP technical specifications, such as 3GPP TS 27.007. While the following discussion provides exemplary command/response tables for various MUSIM AT commands, one or more of the AT commands (and associated command/response tables) can be combined with another AT command or otherwise altered in some examples.

For the purposes of the illustrated command/response tables, the following syntactical definitions apply:
<CR> Carriage return character, which value is specified with command S3.
<LF> Linefeed character, which value is specified with command S4.
< . . . > Name enclosed in angle brackets is a syntactical element. Brackets themselves do not appear in the command line.
[ . . . ] Optional subparameter of a command or an optional part of TA information response is enclosed in square brackets. Brackets themselves do not appear in the command line. When subparameter is not given in parameter type commands, new value equals to its previous value. In action type commands, action should be done on the basis of the recommended default setting of the subparameter.
underline Underlined defined subparameter value is the recommended default setting of this subparameter. In parameter type commands, this value should be used in factory settings which may be configured, for example, by ITU-T Recommendation V.250: “Serial asynchronous automatic dialing and control.” In action type commands, this value should be used when subparameter is not given.

In some examples, the techniques described here provide for a new NAS Connection Release AT command. Such a command can be defined, for example, 3GPP TS 27.007. In some examples, the NAS Connection Release AT command is defined as follows:

+CNASCREL parameter command syntax

| Command | Possible response(s) |
|---|---|
| +CNASCREL = [NAS Connection Release] | +CME ERROR: <err> |
| +CNASCREL? | +CNASCREL: <NAS Connection |
| | Release> |
| +CNASCREL = ? | +CNASCREL: (list of supported <NAS |
| | Connection Release>s) |

### DESCRIPTION

The set command enables the UE to specify a request to release the NAS connection to the network during Normal and Periodic Tracking Area Updating and Service Request procedures in EPS (see, e.g., 3GPP TS 24.301, subclause 5.5.3.2 and subclause 5.6.1) and during Registration and Service Request procedures in 5GS (see, e.g., 3GPP TS 24.501, subclause 5.5.1 and subclause 5.6.1).

Read command returns the current value of <NAS Connection Release>.
Defined values
<NAS Connection Release>: integer type
0: Do not Release the NAS signaling connection
1: Release the NAS signaling connection

In some examples, the techniques described here provide for a new Reject Paging AT command. Such a command can be defined, for example, 3GPP TS 27.007. In some examples, the Reject Paging AT command is defined as follows:

+CREJPAG parameter command syntax

| Command | Possible response(s) |
|---|---|
| +CREJPAG = [Reject Paging] | +CME ERROR: <err> |
| +CREJPAG? | +CREJPAG: <Reject Paging> |
| +CREJPAG = ? | +CREJPAG: (list of supported <Reject |
| | Paging>s) |

### DESCRIPTION

The set command enables the UE to indicate rejection of the paging request to the network when responding to paging during Service Request procedure in EPS (see, e.g., 3GPP TS 24.301 subclause 5.6.1) and during Service Request procedure in 5GS (see, e.g., 3GPP TS 24.501 subclauses 5.6.1).

Read command returns the current value of <Reject Paging.>
Defined values
<Reject Paging>: integer type
0: Do not Reject paging
1: Reject paging

In some examples, the techniques described here provide for a new Paging Restriction AT command. Such a command can be defined, for example, 3GPP TS 27.007. In some examples, the Paging Restriction AT command is defined as follows:

+CPAGRES parameter command syntax

| Command | Possible response(s) |
|---|---|
| +CPAGRES = [<Paging | +CME ERROR: <err> |
| Restrictions>[,<EBI>[,<PDU Session>]]] | |
| +CPAGRES? | +CPAGRES: <Paging Restrictions>, |
| | <EBI>, <PDU Session> |
| +CPAGRES = ? | +CPAGRES: (list of supported <Paging |
| | Restrictions>s), (list of supported |
| | <EBIs>s, (list of supported <PDU |
| | Sessions>s) |

### DESCRIPTION

The set command enables the UE to specify paging restrictions to the network during Normal and Periodic Tracking Area Updating and Service Request procedures in EPS (see, e.g., 3GPP TS 24.301, subclause 5.5.3.2 and subclause 5.6.1) and during Registration and Service Request procedures in 5GS (see, e.g., 3GPP TS 24.501, subclause 5.5.1 and subclause 5.6.1).

Read command returns the current value of <Paging Restrictions> and, in some examples, the current value(s) of <EBI> and/or <PDU Session>.
Defined values
<Paging Restrictions>: integer type
0: Paging is not restricted
1: All paging is restricted
2: All paging is restricted except for voice service
3: All paging is restricted except for specified PDN connection in EPS
4: All paging is restricted except for voice service and specified PDN connection in EPS
5: All paging is restricted except for specified PDU session connection in 5GS
6: All paging is restricted except for voice service and specified PDU session in 5GS

<EBI>: A bitmap that indicates the PDN connection associated with EPS bearer identities for which paging is restricted (see, e.g., 3GPP TS 24.301, clause 9.9.3.66).
0: Paging is restricted for the PDN connection associated with the EPS bearer identity
1: Paging is not restricted for the PDN connection associated with the EPS bearer identity

<PDU Session>: A bitmap that indicates the PDU session for which paging is restricted (see, e.g., 3GPP TS 24.501, clause 9.11.3.77).
0: Paging is restricted for the PDU session
1: Paging is not restricted for the PDU Session

In some examples, the techniques described here provide for a new Paging Collision AT command. Such a command can be defined, for example, 3GPP TS 27.007. In some examples, the Paging Restriction AT command is defined as follows:

+CPAGCOL parameter command syntax

| Command | Possible response(s) |
|---|---|
| +CPAGCOL = [<n>[,<Requested IMSI | +CME ERROR: <err> |
| Offset>]] | |
| +CPAGCOL? | +CPAGCOL: <n>, <Selected IMSI |
| | Offset> |
| +CPAGCOL = ? | +CPAGCOL: (list of supported <n>s), |
| | (list of supported <Requested IMSI |
| | Offset>s) |

### DESCRIPTION

The set command controls the presentation of an unsolicited return code +CPAGCOL: <Selected IMSI Offset> when <n>=1 and there is a change in value of <IMSI Offset> set by the network during Attach and Normal and periodic Tracking Area Updating procedures in EPS (see, e.g., 3GPP TS 24.301 subclauses 5.5.1 and 5.5.3.2) and during Registration and Service Request procedures in 5GS (see, e.g., 3GPP TS 24.501, subclause 5.5.1 and subclause 5.6.1). When <n>=2, the set command also enables the UE to specify the Requested IMSI offset in Attach and TAU and Registration and Service Request procedures.

Read command returns the current value of <Selected IMSI Offset>.
Defined values
<n>: integer type
0: disable paging collision unsolicited result code
1: enable paging collision unsolicited result code+CPAGCOL: <Selected IMSI Offset>
2: set UE Requested IMSI offset for use in ATTACH REQUEST and TAU REQUEST messages (or REGISTRATION REQUEST and SERVICE REQUEST messages)

<Requested IMSI Offset>: integer type, indicates the value of IMSI offset requested by UE in binary format (see, e.g., 3GPP TS 24.301, clause 9.9.3.64).

<Selected IMSI Offset>: integer type, indicates the value of IMSI offset selected by the network in binary format (see, e.g., 3GPP TS 24.301, clause 9.9.3.64).

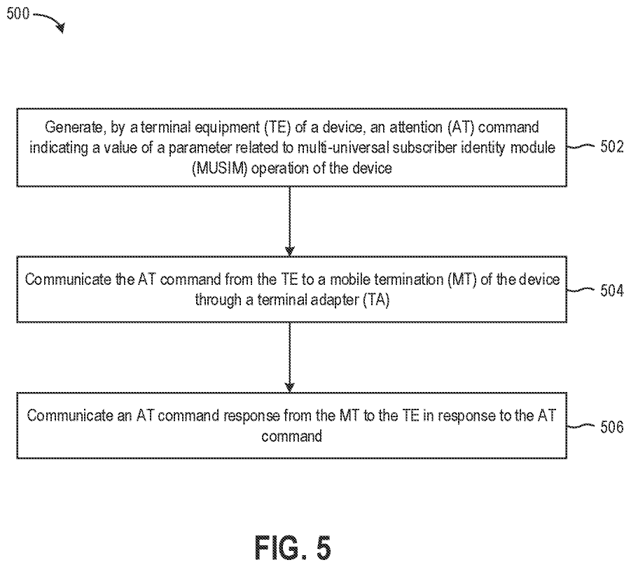

FIG. 5 illustrates an example process 500 for setting and/or retrieving values of MUSIM-related parameters in accordance with an aspect of the present disclosure. In some examples, the process 500 is performed by one or more of the devices or systems described herein, such as the UE 101 or components thereof.

Operations of the process 500 include generating 502, by a TE of a device, an AT command. The AT command can indicate a value of a parameter related to MUSIM operation of the device. The TE (e.g., the TE 402 of the device 400) can include processing circuitry, such a processor and/or other application circuitry (e.g., the application circuitry 305). In some examples, the AT command can be generated in response to an indication received from an application (e.g., an application 408) executing on the device performing the process 500, such as an operating system of the device or an application interfacing with the operating system of the device.

In some examples, the MUSIM-related parameter is a NAS connection release parameter. The value of the NAS connection release parameter can indicate to a MT (e.g., via the TA) whether to release a NAS connection between the device and a network node, such as a NAS connection associated with a particular USIM. In some examples, the MUSIM-related parameter is a paging rejection parameter. The value of the paging rejection parameter can indicate to the MT (e.g., via the TA) whether to reject a paging request to the device by a network node, such as a paging request associated with a particular USIM.

In some examples, the MUSIM-related parameter includes one or more paging restriction parameter(s). The value of one of the paging restriction parameters can indicate to the MT (e.g., via the TA) paging restriction(s) for the device, such as paging not restricted, all paging restricted, all paging restricted except for voice service, all paging restricted except for a specified PDN connection in EPS or a specified PDU session in 5GS, or all paging restricted except for voice service and the specified PDN connection or PDU session, among others In some examples, one or more other paging restriction parameters can include one or more bitmaps that indicate the specified PDN connection and/or PDU session associated with the restriction(s).

In some examples, the MUSIM-related parameter includes one or more paging collision parameters. The value of the one of the paging collision parameters can indicate to the MT (e.g., via the TA) whether to present an unsolicited return code in response to a change in an IMSI offset associated with the device (or a particular USIM of the device) In some examples, one or more other paging collision parameters can indicate a request IMSI offset for the device (e.g., for a particular USIM of the device) or a selected IMSI offset for the device.

The AT command is communicated 504 from the TE to a MT of the device through a TA. The MT and the TA can be, for example, the MT 404 and the TA 406 of the device 400. In some examples, the MT and/or the TA include or are implemented by processing circuitry, such as a processor and/or other baseband circuitry (e.g., the baseband circuitry 310).

In some examples, the MT can send a message to a network node based on the value of the parameter included in the AT command. For example, the MT can send a message to the network node (e.g., a MME in EPS or an AMF in 5GS) indicating whether to release the NAS connection based on the value of the NAS connection release parameter, a message indicating whether the device has rejected paging based on the value of the paging rejection parameter, a message indicating one or more paging restrictions based on the value(s) of the paging restriction parameter(s), a message indicating a requested IMSI offset or whether to present an unsolicited return code in response to a change in an IMSI offset based on the value(s) of the paging collision parameter(s), or combinations of them, among others. In some examples, some or all of these indications are made during a TAU Request or Service Request procedure in EPS, or during a Registration Request or Service Request procedure in 5GS.

In some examples, an AT command response is communicated 506 from the MT to the TE through the TA. Such a response can be based on a message received from a network node (e.g., a MME or an AMF) during, for example, a TAU Request or Service Request procedure in EPS, or a Registration Request or Service Request procedure in 5GS. Data indicative of this response can be stored in memory or another storage device, provided to an application executing on the device, or both. In some examples, other data associated with the AT command (e.g., the value of the parameter) can also be stored.

For one or more embodiments, at least one of the components set forth in one or more of the preceding figures may be configured to perform one or more operations, techniques, processes, and/or methods as set forth in the example section below. For example, processing circuitry, which can include the application circuitry and/or the baseband circuitry described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 is an apparatus of a user equipment (UE), the apparatus including processing circuitry comprising a TE, a MT and a TA, the TE arranged to communicate with the MT through the TA, the processing circuitry arranged to: provide requests from a MUSIM device (e.g., UE) to a network endpoint (e.g., a MME in EPS or an AMF in 5GS) for handling NAS signaling connection or incoming paging from a CN or a RAN; indicate paging restrictions in the MUSIM device to the network endpoint for restricting paging from the CN or the RAN on one USIM; and negotiate an IMSI offset value between the MUSIM device and the network endpoint so as to avoid paging collisions across the multiple USIMs; in which the TE is arranged to generate at least one AT command for communication to the MT through the TA to indicate a MUSIM device request type, paging restrictions or IMSI offset (e.g., at the ME) related to operation of the MUSIM device; and in which the MT is arranged to communicate with the network endpoint to: indicate to the network endpoint, based on the at least one AT command, the MUSIM device request type (e.g., UE request type), paging restrictions or IMSI offset; and a memory to store the UE request type, paging restrictions or IMSI offset.

Example 2 is the apparatus of example 1 in which the MT is further arranged to indicate the MUSIM device request type of NAS connection release in a TAU Request or Service Request at MME in EPS and/or a Registration Request or Service Request at AMF in 5GS.

Example 3 is the apparatus of example 1 or 2 in which the at least one AT command indicates the MUSIM device request to release a NAS signaling connection through a <NAS Connection Release> parameter, the <NAS Connection Release> parameter configured to indicate whether the NAS connection should be released or not.

Example 4 is the apparatus of any of examples 1 to 3 in which the MT is further arranged to indicate the MUSIM device request type of reject paging in a Service Request at MME in EPS and Service Request at AMF in 5GS.

Example 5 is the apparatus of any of examples 1 to 4 in which the at least one AT command indicates the MUSIM device request to reject paging through a <Reject Paging> parameter, the <Reject Paging> parameter configured to indicate whether the incoming CN page in RRC_IDLE or RAN page in RRC INACTIVE should be rejected by the UE or not.

Example 6 is the apparatus of any of examples 1 to 5 in which the MT is further arranged to indicate paging restrictions in a TAU Request and Service Request at MME in EPS and Registration Request and Service Request at AMF in 5GS.

Example 7 is the apparatus of any of examples 1 to 6 in which the at least one AT command indicates the paging restrictions specified by MUSIM device through a <Paging Restrictions> and <EBI> parameter in EPS, the <Paging Restrictions> parameter configured to indicate whether the incoming paging is not restricted; whether all incoming paging is restricted; whether all paging is restricted except for voice service; whether all paging is restricted except for specified PDN connection in EPS; whether all paging is restricted except for voice services and specified PDN connection in EPS; and the parameter <EBI> configured to indicate the PDN connection associated with EPS bearer identities for which paging is restricted.

Example 8 is the apparatus of any of examples 1 to 7 in which the at least one AT command indicates the paging restrictions specified by MUSIM device through a <Paging Restrictions> and <PDU session> parameter in 5GS, the <Paging Restrictions> parameter configured to indicate whether the incoming paging is not restricted; whether all incoming paging is restricted; whether all paging is restricted except for voice service; whether all paging is restricted except for specified PDU session in 5GS; whether all paging is restricted except for voice services and specified PDU session in 5GS; and the parameter <PDU session> configured to indicate PDU session for which paging is restricted.

Example 9 is the apparatus of any of examples 1 to 8 in which the TE is further arranged to indicate the change in the paging restrictions to the MT in a +CPAGRES AT command via a <Paging Restrictions> parameter, the <Paging Restrictions> parameter configured to indicate whether the paging is restricted or not.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods described here may be implemented in software, hardware, or a combination thereof, in different implementations. In addition, the order of the blocks of the methods may be changed, and various elements may be added, reordered, combined, omitted, modified, and the like. Various modifications and changes may be made as would be obvious to a person skilled in the art having the benefit of this disclosure. The various implementations described here are meant to be illustrative and not limiting. Many variations, modifications, additions, and improvements are possible. Accordingly, plural instances may be provided for components described here as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of implementations as defined in the claims that follow.

1. A device, comprising:
processing circuitry comprising a terminal equipment (TE), a mobile terminal (MT) and a terminal adapter (TA), the processing circuitry configured to:
generate, by the TE, an attention (AT) command, wherein the AT command indicates a value of a parameter related to multi-universal subscriber identity module (MUSIM) operation of the device; and
communicate the AT command from the TE to the MT through the TA; and
memory configured to store data related to the value of the parameter related to MUSIM operation of the device.

2. The device of claim 1, wherein the parameter comprises a Non-Access Stratum (NAS) connection release parameter, and wherein the value of the NAS connection release parameter indicates whether to release a NAS connection between the device and a network node.

3. The device of claim 2, wherein the MT is configured to indicate to the network node whether to release the NAS connection between the device and the network node based on the value of the NAS connection release parameter.

4. The device of claim 1, wherein the parameter comprises a paging rejection parameter, and wherein the value of the paging rejection parameter indicates whether to reject paging of the device by a network node.

5. The device of claim 4, wherein the MT is configured to indicate to the network node whether to the device has rejected paging based on the value of the paging rejection parameter.

6. The device of claim 1, wherein the parameter comprises a paging restriction parameter, and wherein the value of the paging restriction parameter indicates whether paging is not restricted, all paging is restricted, all paging is restricted except for voice service, all paging is restricted except for a specified public data network (PDN) connection or protocol data unit (PUD) session, or all paging is restricted except for voice services and the specified PDN connection or PDU session.

7. The device of claim 6, wherein a value of a one or more other paging restriction parameters indicate the specified PDN connection or PDU session.

8. The device of claim 6, wherein the MT is configured to indicate to a network node one or more paging restrictions based on the value of the paging restriction parameter.

9. The device of claim 1, wherein the parameter comprises a paging collision parameter, and wherein the value of the paging collision parameter indicates whether to present an unsolicited return code in response to a change in an international mobile subscriber identity (IMSI) offset associated with the device.

10. The device of claim 1, wherein the parameter comprises a paging collision parameter, and wherein the value of the paging collision parameter indicates a requested IMSI offset for the device or a selected IMSI offset for the device.

11. The device of claim 1, wherein the MT is configured to transmit, to a network node, a message based on the value of the parameter during an Evolved Packet System Mobility Management (EMM) Tracking Area Update or Service Request procedure, or during a 5G Mobility Management (5GMM) Registration Request or Service Request procedure.

12. The device of claim 1, wherein the processing circuitry is configured to communicate an AT command response from the MT to the TE through the TA in response to the AT command.

13. A method, comprising:
generating, by a terminal equipment (TE) of a device, an attention (AT) command, wherein the AT command indicates a value of a parameter related to multi-universal subscriber identity module (MUSIM) operation of the device; and
communicating the AT command from the TE to a mobile terminal (MT) of the device through a terminal adapter (TA).

14. The method of claim 13, wherein the parameter comprises a Non-Access Stratum (NAS) connection release parameter, and the value of the NAS connection release parameter indicates whether to release a NAS connection between the device and a network node, or wherein the parameter comprises a paging rejection parameter, and the value of the paging rejection parameter indicates whether to reject paging of the device by a network node.

15. The method of claim 13, wherein the parameter comprises a paging restriction parameter, and wherein the value of the paging restriction parameter indicates whether paging is not restricted, all paging is restricted, all paging is restricted except for voice service, all paging is restricted except for a specified public data network (PDN) connection or protocol data unit (PUD) session, all paging is restricted except for voice services and the specified PDN connection or PDU session.

16. The method of claim 13, wherein the parameter comprises a paging collision parameter, and wherein the value of the paging collision parameter indicates whether to present an unsolicited return code in response to a change in an international mobile subscriber identity (IMSI) offset associated with the device, indicates a requested IMSI offset for the device, or indicates a selected IMSI offset for the device.

17. At least one non-transitory computer-readable medium storing instructions executable by at least one processor to perform operations comprising:
generating, by a terminal equipment (TE) of a device, an attention (AT) command, wherein the AT command indicates a value of a parameter related to multi-universal subscriber identity module (MUSIM) operation of the device; and
communicating the AT command from the TE to a mobile terminal (MT) of the device through a terminal adapter (TA).

18. The at least one non-transitory computer-readable medium of claim 17, wherein the parameter comprises a Non-Access Stratum (NAS) connection release parameter, and the value of the NAS connection release parameter indicates whether to release a NAS connection between the device and a network node, or wherein the parameter comprises a paging rejection parameter, and the value of the paging rejection parameter indicates whether to reject paging of the device by a network node.

19. The at least one non-transitory computer-readable medium of claim 17, wherein the parameter comprises a paging restriction parameter, and wherein the value of the paging restriction parameter indicates whether paging is not restricted, all paging is restricted, all paging is restricted except for voice service, all paging is restricted except for a specified public data network (PDN) connection or protocol data unit (PUD) session, all paging is restricted except for voice services and the specified PDN connection or PDU session.

20. The at least one non-transitory computer-readable medium of claim 17, wherein the parameter comprises a paging collision parameter, and wherein the value of the paging collision parameter indicates whether to present an unsolicited return code in response to a change in an international mobile subscriber identity (IMSI) offset associated with the device, indicates a requested IMSI offset for the device, or indicates a selected IMSI offset for the device.
